(19) United States
(12) Patent Application Publication
(10) Pub. No.: US 2026/0037497 A1
(43) Pub. Date: Feb. 5, 2026

(54) INFORMATION PROCESSING SYSTEM

(71) Applicant: Toshiba Tec Kabushiki Kaisha, Tokyo (JP)

(72) Inventor: Takesi KAWAGUTI, Mishima Shizuoka (JP)

(21) Appl. No.: 19/246,207

(22) Filed: Jun. 23, 2025

(30) Foreign Application Priority Data
Aug. 1, 2024 (JP) 2024-125568

(51) Int. Cl. G06F 16/23; G06F 16/242; G06F 16/2452

(52) U.S. Cl. CPC G06F 16/2365; G06F 16/243; G06F 16/24522

(57) ABSTRACT

According to one embodiment, an information processing system includes an information processing device and a structured database accessible by a specialized query language. The information processing device receives a natural language query related to information in the structured database and provides a natural language response to the natural language query by supplying the natural language query to a large language model (LLM) accessing a retrieval-augmented generation (RAG) database incorporating information from the structured database. The information processing device is configured to automatically update information in the RAG database by retrieving information from the structured database by executing a predefined query in the specialized query language to access the structured database, converting results from the predefined query into natural language text according to a predefined conversion rule associated with the predefined query, and storing the natural language text in the RAG database.

### CROSS-REFERENCE TO RELATED APPLICATION

This application is based upon and claims the benefit of priority from Japanese Patent Application No. 2024-125568, filed Aug. 1, 2024, the entire contents of which are incorporated herein by reference.

### FIELD

Embodiments described herein relate to an information processing system.

### BACKGROUND

In the related art, analysis using information stored in a database (DB), such as a relational database (RDB), is often performed, but to obtain an appropriate analysis result, the person who executes the analysis generally needs to have specialized knowledge and experience related to interacting with the database.

In recent years, a technique for enabling analysis without specialized knowledge or experience by using a large-scale language model (LLM) has been proposed.

However, to obtain a correct answer by directly using information stored in a structured DB, such as an RDB, through interaction with the LLM, the LLM needs to learn the data structure of the DB (for example, the items, column headings, entries, records, and the like included in data tables and the like).

For example, for sales data such as from retail stores and mass retailers, information about the merchandise available in the stores, information about transactions (sales) at the store, and the like are often tracked in a DB, such as a RDB, and updated daily. If such daily updated information could be used by a store clerk, a customer, or other user who lacks specialized knowledge that is normally necessary to retrieve such information from a database, such users might be more effective in predicting demand and/or promoting sales. Therefore, there is a demand for a system that enables usage of database information through natural language interaction. However, the related art (for example, Japanese Patent No. 7396582) does not solve this problem.

### BRIEF DESCRIPTION OF THE DRAWINGS

FIG. 1 is a diagram illustrating an example of a system configuration in an embodiment.

FIG. 2 is a diagram illustrating an example of a hardware configuration of an information processing device.

FIG. 3 is a table illustrating an example of associations determined by a conversion definition file.

FIG. 4 is a block diagram illustrating an example of a hardware configuration of an input and output device.

FIG. 5 is a block diagram illustrating an example of functional aspects of a system of an embodiment.

FIG. 6 is a flowchart of conversion processing by a processing unit.

FIG. 7 is a diagram illustrating an example of data extracted from a relational database.

FIG. 8 is a diagram illustrating an example of a filled text sentence.

### DETAILED DESCRIPTION

An embodiment provides an improvement in accessibility of information stored in a structured database or the like that may be frequently updated. An embodiment provides an improvement to existing systems by providing access to such database information by natural language user interactions without necessarily requiring direct access to the structured database by the user.

In general, according to one embodiment, an information processing system includes an information processing device and a structured database accessible by a specialized query language. The information processing device is configured to receive a natural language query related to information in the structured database and provide a natural language response to the natural language query by supplying the natural language query to a large language model (LLM) accessing a retrieval-augmented generation n (RAG) database incorporating information from the structured database. The information processing device is further configured to automatically update information in the RAG database by retrieving information from the structured database by executing a predefined query in the specialized query language to access the structured database, converting results from the predefined query into natural language text according to a predefined conversion rule associated with the predefined query, and storing the natural language text in the RAG database.

### First Embodiment

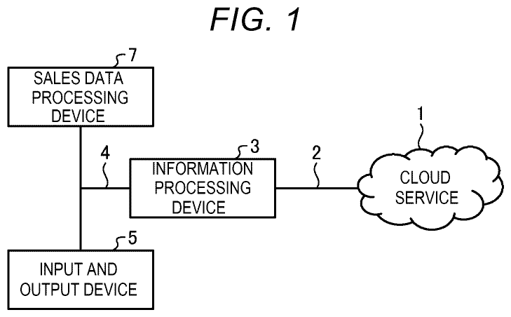

An embodiment will be described with reference to the drawings. FIG. 1 is a diagram illustrating an example of a system configuration in the present embodiment. The system of the first embodiment is, for example, a sales data management system used in a retail store. The system includes a cloud service 1, an information processing device 3, an input and output (I/O) device 5, a sales data processing device 7, a network 2, and a network 4.

The network 2 is, for example, the Internet, and the network 4 is, for example, a LAN provided in a store. The network 2 communicably connects the information processing device 3 and the cloud service 1. Accordingly, various services provided by the cloud service 1 can be used by the information processing device 3. The network 4 communicably connects the information processing device 3 to the I/O device 5 and the sales data processing device 7.

As networks 2 and 4, the Internet, or other network types such as a virtual private network (VPN), a local area network (LAN), a public communication network, and a mobile communication network can be used alone or in combination as appropriate. The number of devices included in the system is not limited to the illustrated example.

The information processing device 3 is, for example, a server device provided in a back office of a store. The information processing device 3 stores various types of information related to the store and its operations, such as information about the merchandise handled in the store and information about sales at the store. In some examples, the information processing device 3 may be provided at a head office of a store group, such as store chain or the like, and may store information for multiple stores of the same group. In the present example, the store is a retail business selling merchandise to customers, but embodiments are not limited thereto.

In the present embodiment, the information processing device 3 is illustrated as a single device, but in implementation, the information processing device 3 may be a plurality of devices acting in concert or collectively. In some examples, the information processing device 3 may be a cloud server (or a cloud system) as implemented by a network-connected device.

The I/O device 5 can be any device that can be used for obtaining the output from the information processing device 3 and for providing input to the information processing device 3. The I/O device 5 is, for example, a mobile terminal device, a personal computer (PC), a tablet terminal, or a smartphone. The I/O device 5 may be provided by the store or otherwise made accessible to users.

In some examples, I/O device 5 may be, or integrated with, the sales data processing device 7. The I/O device 5 may be or incorporate a printer or a copier provided in the store. The I/O device 5 may be a stationary device provided at the store such as on the sales floor of the store or in the back office. I/O device 5 may be a device connected remotely to the information processing device 3 from a user's home or a user's location.

Potential users of the I/O device 5 in this example may be a store clerk, an employee, or a shopper. The store clerk is a person working at the store. In this context, an employee user is a person who works at the head office.

The sales data processing device 7 is a device that performs sales time information management including registration processing of merchandise, settlement (payment) processing of registered merchandise, and the like, and is, for example, a point-of-sale (POS) terminal or a self-service point-of-sale (POS) terminal having a merchandise registration function and a settlement function, a merchandise registration terminal having a merchandise registration function, a settlement terminal having a settlement function, or the like. In the present description, “POS” also means or refers to “sales time information management”.

The self-service POS terminal is a device for a customer to perform registration processing and settlement processing by himself or herself. Other examples of the sales data processing device 7 include a registration device and a payment device constituting together a semi-self-service POS. In this context, the registration device is a device by which the registration processing is performed by an operation of a store clerk. The payment device is a device by which the settlement processing is performed by an operation of the customer (shopper).

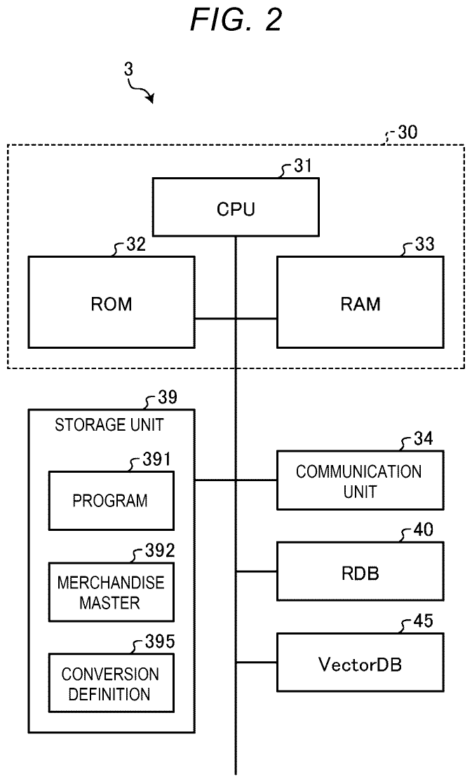

FIG. 2 is a diagram illustrating an example of a hardware configuration of the information processing device 3. The information processing device 3 includes a central processing unit (CPU) 31, a read only memory (ROM) 32, a random access memory (RAM) 33, a communication unit 34, a storage unit 39, a relational database (RDB) 40, and a Vector database (vector DB) 45.

The communication unit 34 is a wired or wireless communication interface that can be connected to the networks 2 and 4. The communication unit 34 communicates with an external device such as the I/O device 5 and the cloud service 1 via the networks 2 and 4. For example, the communication unit 34 exchange information with the user currently logged in to the I/O device 5 via an operation reception screen provided on the I/O device 5.

The CPU 31 is an example of a processor and comprehensively controls operations of the information processing device 3. The ROM 32 stores various programs. The RAM 33 is a workspace for loading programs and various types of data.

The CPU 31, the ROM 32, and the RAM 33 are connected via a bus or the like to constitute a control unit 30 having a computer configuration. In the control unit 30, the CPU 31 executes various types of processing when the CPU 31 operates according to the programs stored in the ROM 32 or the storage unit 39 and loaded on the RAM 33.

The storage unit 39 is implemented as a non-volatile storage medium such as a hard disk drive (HDD), a flash memory, or the like, and maintains storage contents even when power is cut off. The storage unit 39 stores a program 391 that can be executed by the CPU 31 and various types of setting information.

The storage unit 39 stores a merchandise master 392 in which information about merchandise (merchandise information) available in the store is collected. The storage unit 39 also stores a conversion definition file 395 in which a conversion rule is associated with an SQL statement.

The RDB 40 and the Vector DB 45 are stored in a non-volatile storage medium such as an HDD or a flash memory included in the information processing device 3.

The RDB 40 is an example of a structured database and stores transaction information acquired by the sales data processing device 7.

The Vector DB 45 is a knowledge base for a retrieval-augmented generation (RAG) technique for assigning specific information to an LLM. Here, the LLM is an abbreviation for large language model or a large-scale language model.

The Vector DB 45 in the present embodiment is a database in which information from the RDB 40 is stored as unstructured data that can be more readily extracted by the LLM.

The Vector DB 45 is constructed and updated by registering a text sentence. The text sentence registered in the Vector DB 45 is obtained by converting the information extracted from the RDB 40 into an expression in a natural language according to a predefined conversion rule. The extraction of information from the RDB 40 is performed by a predefined SQL statement. The SQL statement and the conversion rule are associated with each other in the conversion definition file 395.

The storage unit 39, the RDB 40, and the Vector DB 45 may store other information in addition to that specifically mentioned here. Various information stored in the storage unit 39, the RDB 40, and the Vector DB 45 may be acquired in advance from the I/O device 5, or another external device, via the networks 2 and 4. Such information may be automatically acquired and/or updated as appropriate.

In the following, the merchandise master 392 and the transaction information may each, individually or collectively, be referred to as “POS data”. In other words, the “POS data” as used below can be either or both data from the merchandise master 392 or transaction information 79.

### Merchandise Master

The merchandise master 392 is a collection of information about the merchandise available in the store. The merchandise master 392 is stored in the storage unit 39 as, for example, a data table. Items (entries) included in the data table as part of the merchandise master 392 are, for example, as follows:
Merchandise code
Merchandise name
Unit price
Available period
Merchandise image data
Verification data

The merchandise code is information (identification information) for uniquely identifying particular merchandise. The merchandise code is, for example, a Japanese article number (JAN) code number. The other information (a merchandise name, a unit price, verification data, and the like) is stored in association with the merchandise code. The item “merchandise name” is a name of the merchandise. The item “unit price” is the price of one unit of the merchandise.

The item “available period” can be an availability start date, an availability end date, a subset of the days of the week, or date ranges or other time periods. For a merchandise that is always available without any particular specification related to availability, the “available period” entry may be blank. When an availability end date is set, the end date may be set in “available period” entry even before the end date is reached.

A future available start date can be set indicating that merchandise will become available at the store at a later time. Similarly, an available end date can set for a future time after which the merchandise will no longer be available at the store. Days of the week or other dates can be set to indicate the merchandise is available at the store only on certain days or dates.

By defining the item “available time” appropriately, information about merchandise that was available in the past or merchandise that will become available in future can be known/designated. In addition, by creating records having the same merchandise code but a different “available time” value, factors such as changes in unit price over time (or in different time periods) may be identified.

The entry for “merchandise image data” is provided for displaying an image indicating an appearance or the like of the merchandise. Such data may also be used for posting flyers.

In the item “verification data” a feature value serving as a reference value is stored. A device that performs sales data processing can recognize merchandise by comparing a feature value determined from captured images from a camera or the like to the stored verification data to obtain the merchandise code associated with the matching (or best matching) verification data. The determination of matching can be performed by, for example, calculating a similarity between the merchandise feature value from the captured image and the stored verification data (reference values, comparing the calculated similarity to a threshold, and determining that the verification data matches if the similarity is equal to or greater than the threshold. In some examples, a merchandise code may be acquired by reading (scanning or decoding) a code symbol, such as a barcode or a two-dimensional code, attached to the merchandise.

### Transaction Information

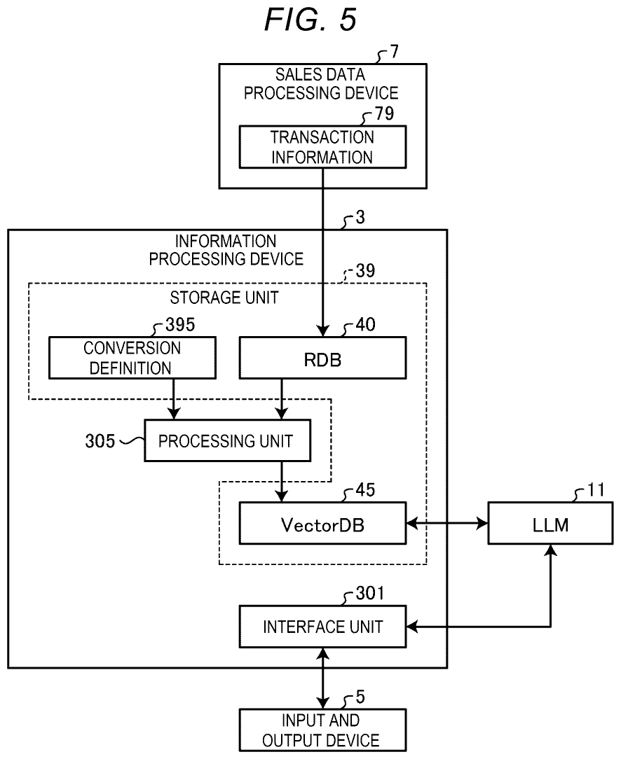

The transaction information stored in the RDB 40 is information about the merchandise purchased by customers. This transaction information is from the transaction information 79 (see FIG. 5) registered at the sales data processing device(s) 7 in the store. The transaction information in the RDB 40 may include not only information about a particular host store or the like but also the transaction information received from a sales data processing device at one or more other stores.

The transaction information is summarized, for example, as a data table. Items (entries) included in the transaction information are, for example, as follows:
Store ID
Terminal ID
Transaction ID
Date and time
Member ID
Merchandise information
Transaction amount

In the item “store ID”, a store where the transaction of the associated record was performed is identified. The store ID can be a number, name, or other designation. The item “terminal ID” stores the terminal ID of the sales data processing device that performed the transaction. The terminal ID entry is identification information of a sales data processing device, which is generally allocated so as not to overlap with other sales data processing device at least at the same store.

The transaction ID is identification information of the transaction. Generally, the transaction ID is automatically assigned when the merchandise registration processing related to the transaction begins. Typically, the transaction ID is a number that increments sequentially with each new transaction. In the item “date and time”, the date and time when the transaction of the record was performed is stored.

If the customer involved with the transaction presents a member ID, this member ID may be stored in the item “member ID”. The member ID is identification information of the customer. Generally, a member is a customer who has registered with a store loyalty program or the like. For example, the member ID is a unique number assigned to each member upon registration in the loyalty program or the like.

The item “transaction amount” is a total price (total amount) of all the merchandise purchased in the transaction of the record.

In this example, there will be one transaction amount for the combination of store ID, terminal ID, and transaction ID. However, the merchandise information incorporated into the transaction information on a transaction ID basis is not limited, and merchandise information for each item of merchandise in a sales transaction may be included in the transaction information associated with a single transaction ID. Such merchandise information includes, for example, the following items:

### Merchandise Information

Merchandise code
Merchandise name
Unit price
Quantity
Price

The merchandise code, the merchandise name, and the unit price are as described above. The item “quantity” is the quantity (e.g., a number, weight, or volume) of the merchandise corresponding to the merchandise code in the transaction of the record. The item “price” is a value obtained by multiplying the unit price (or selling price) by the quantity.

### Conversion Definition

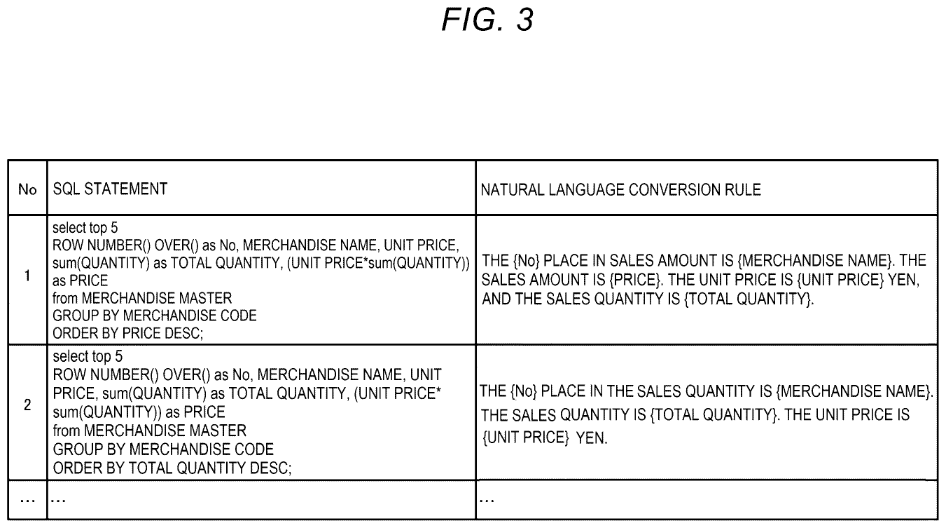

The conversion definition file 395 defines an association between an SQL statement and a conversion rule for the information acquired by the SQL statement. The conversion definition file 395 records one or more combinations of SQL statement and conversion rule as illustrated in FIG. 3.

FIG. 3 is a table illustrating an example of an association set by the conversion definition file 395. The conversion definition file provides a one-to-one 395 correspondence between a SQL statement and a conversion rule. In this context, SQL is a language for operating or accessing a database. The SQL statement here is, for example, an instruction sentence starting with “select” for instructing an extraction of information, and designates, for example, a data table stored in the RDB 40 and items included in the data table.

The conversion rule is a sentence (text sentence) in natural language and includes a blank or blanks to be filled with information as acquired by executing the associated SQL statement. A blank may be referred to as a hole portion or a variable text portion is indicated in FIG. 3 and the following by a sandwiching of an item designated in the SQL statement to be incorporated into the hole portion with brackets (“{item}”).

As illustrated in FIG. 3, the SQL statement is, for example, one of the following (1) or (2).

### SQL Statement (1):

select top 5
ROW NUMBER( ) OVER( ) as No, merchandise name, unit price, sum(quantity) as TOTAL QUANTITY, (unit price*sum(quantity)) as PRICE
from merchandise master
GROUP BY merchandise code
ORDER BY PRICE DESC;

### SQL Statement (2):

select top 5
ROW NUMBER( ) OVER( ) as No, merchandise name, unit price, sum(quantity) as TOTAL QUANTITY, (unit price*sum(quantity)) as PRICE
from merchandise master
GROUP BY merchandise code
ORDER BY TOTAL QUANTITY DESC;

For example, natural language conversion rules, such as the following sentences (3) and (4), are respectively associated with the SQL statements (1) and (2) above.
Sentence (3): The {No} place in sales amount is {merchandise name}. The sales amount is {PRICE}. The unit price is {unit price} yen, and the sales quantity is {TOTAL QUANTITY}.
Sentence (4): The {NO} place in the sales quantity is {merchandise name}. The sales quantity is {TOTAL QUANTITY}. The unit price is {unit price} yen.

By the conversion association as described above, a natural language sentence can be obtained, in which items (merchandise name, unit price, total quantity, price, and the like) as obtained by executing a SQL statement is provided based on a conversion rule.

In FIG. 3, for convenience, the association between the SQL statement and the conversion rule is illustrated in a table form, but the conversion definition file 395 does not need to be in a table form. In other examples, conversion definition file 395 can be a file in a text format.

### Vector DB

The Vector DB 45 is constructed and updated based on a text sentence that receives inputs of information (details) from the RDB 40. The text sentence is obtained by converting the information extracted from the RDB 40 by the SQL statement according to the predefined (in the conversion definition file 395) conversion rule associated with the SQL statement. Therefore, the Vector DB 45 is based on at least a part of the information stored in the RDB 40, thusly reflects the information of the RDB 40, and can be considered to be a re-expression of the information in the RDB 40.

The various data stored in the storage unit 39, the RDB 40, and the Vector DB 45 of the information processing device as illustrated in FIG. 2 are examples, and the present disclosure is not limited thereto.

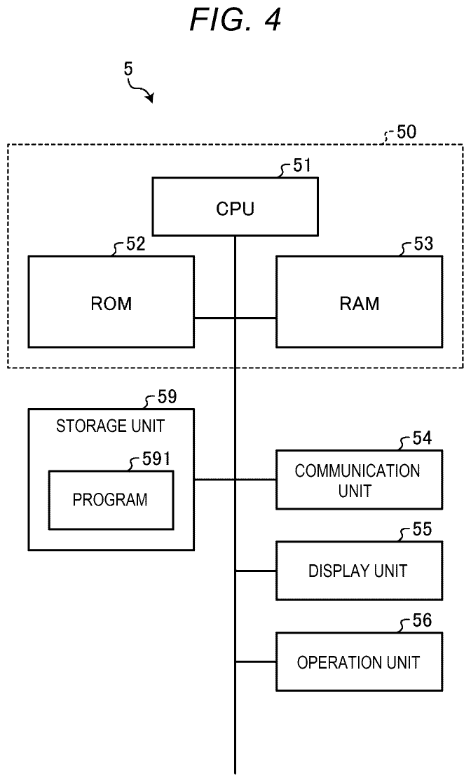

FIG. 4 is a block diagram illustrating an example of a hardware configuration of the I/O device 5. The I/O device 5 includes a CPU 51, a ROM 52, a RAM 53, a communication unit 54, a display unit 55, an operation unit 56, a storage unit 59, and the like. Since the CPU 51, the ROM 52, the RAM 53, a control unit 50, and the storage unit 59 correspond, in general, to the CPU 31, the ROM 32, the RAM 33, the control unit 30, and the storage unit 39 already described above.

The communication unit 54 is a communication interface that communicably connects the control unit 50 to an external device (for example, the information processing device 3) via the network 4.

The display unit 55 and the operation unit 56 provide a graphical user interface (GUI). The GUI is an example of an operation reception screen for receiving user operations. The display unit 55 can be a display device, such as an LCD, and displays various types of information under the control of the CPU 51. The operation unit 56 may comprise an input device such as a touch panel, a keyboard, or a pointing device.

The storage unit 59 stores a program 591 executable by the CPU 51. When the CPU 51 executes the program 591, the control unit 50 implements various functional units or the described functions thereof.

For example, the control unit 50 opens or executes a web browser by executing the program 591. The I/O device 5 of the present embodiment provides the user with a GUI for interacting with an interface unit 301 (see FIG. 5) of the information processing device 3 via a web browser displayed by the display unit 55. That is, the interface unit 301 of the information processing device 3 provides a web page that can be displayed by the web browser of the I/O device 5, and includes a GUI provided on or by the web page. In some examples, the I/O device 5 may be configured to interact with the interface unit 301 by a GUI provided by dedicated application software rather a separate web browser.

### Functional Units

FIG. 5 is a block diagram illustrating an example of functional units included in the system and information exchange between the functional units. The information processing device 3 implements various functional units such as the interface unit 301 and a processing unit 305 by the control unit 30 operating according to the program 391 stored in the storage unit 39. More specifically, the program 391 executed by the information processing device 3 has a module configuration corresponding to the functional units (the interface unit 301 and the processing unit 305) described above. The CPU 31 (processor) reads the program 391 from a storage medium such as the storage unit 39. The functional units are merely examples, and the information processing device 3 may have other functions.

The program 391 may be stored in the storage unit 39 in advance, or may be provided by being downloaded to the information processing device 3 via a network. The program executed by the information processing device 3 may be provided or distributed via a network such as the Internet. The program executed by the information processing device 3 may be provided as a file in an installable form or an executable form recorded on a computer-readable recording medium. Some or all of the functional configurations of the information processing device 3 may have a hardware configuration implemented as a dedicated circuit or the like mounted on the information processing device 3.

In the present embodiment, the cloud service 1 provides an LLM 11. However, there is no limitation in this implementation, and the information processing device 3 may itself include or provide the LLM 11. A large-scale language model (LLM) is a type of generative artificial intelligence (AI) specialized for natural language processing. The LLM 11 may be a general-purpose LLM or a dedicated LLM that is uniquely developed for the store location or the like.

The I/O device 5 receives a question from the user and transmits the question to the information processing device 3. The question may be received as text or speech. The question is transmitted, for example, as character information (text data) to the information processing device 3.

The interface unit 301 transmits the question to the LLM 11, and receives an answer (or response) from the LLM 11.

The LLM 11 acquires information from the Vector DB 45 based on a user request (question or instruction) received by the interface unit 301 in a text form in a natural language called a prompt, and outputs the information to the interface unit 301.

More specifically, upon receiving the prompt from the interface unit 301, the LLM 11 searches the Vector DB 45 based on the prompt to acquire a search result, generates an answer to the prompt in natural language using the prompt and the search result, and outputs the generated answer to the interface unit 301.

Here, the interface unit 301 is an example of a reception unit and a response unit. The interface unit 301 as a reception unit receives an input of a request related to the execution of an analysis of data related to the transaction information from the I/O device 5 in natural language. The received natural language request is also referred to as a prompt.

The LLM 11 acquires information from the Vector DB 45 based on the prompt, generates a natural language response (answer) to a request (question).

Then, the interface unit 301, serving as a response unit, returns the output from the LLM 11 to the I/O device 5 via the communication units 34 and 54.

Referring back to FIG. 5, the interface unit 301 provides a GUI to the I/O device 5. For example, the GUI is provided as a web page. The user interacts with the interface unit 301 via the GUI displayed by the I/O device 5. The interface unit 301 sends the natural language request from the I/O device 5 to the LLM 11, and outputs the natural language response from the LLM 11 to the I/O device 5.

According to the conversion definition in which the instruction sentence for extracting information stored in the structured database and the sentence including the blank portions (blanks) to be filled with information extracted by the execution of the instruction sentence are associated with each other, the processing unit 305 periodically executes the instruction sentence, performs the processing for filling the blank portions of the sentence with the information obtained by the execution of the instruction sentence, and performs update processing for updating the unstructured data using a sentence in which the blanks have been filled.

The processing unit 305 converts the information stored in the RDB 40 into the Vector DB 45 according to the definition of the conversion definition file 395. This conversion processing can be periodically executed during daily operations by registering a schedule in a scheduler or the like. The execution frequency of this conversion processing can be, for example, every week or every month. As a result, the Vector DB can be periodically updated.

For example, the following information, data (11), data (12), and data (13), is acquired from the RDB 40 at a frequency of once a week and added to the Vector DB 45. Data (11): Information about the merchandise items from 1st to 10th (top 10) as ranked from the highest sales amount during the period from “one week before the current date” to “the current date”; Data (12) Information about the top 10 merchandise items in terms of sales value during the period from “one week before the current date” to “the current date”; Data (13) Information about the top 10 merchandise item with the largest increase in sales volume for the period from “one week before the current date” to “the current date”

For the examples described above, the following conversion rules (21) to (23) are prepared. Rule (21): a combination of an SQL statement for acquiring the information of data (11) and a rule for converting an execution result from SQL into natural language, Rule (22): a combination of an SQL statement for acquiring the information of data (12) and a rule for converting an execution result from SQL into natural language, Rule (23) a combination of an SQL statement for acquiring the information of data (13) and a rule for converting an execution result from SQL into natural language

The processing unit 305 executes the conversion rules (21) to (23) once a week to create three natural language sentences to be added to the Vector DB 45. The processing unit 305 combines the three natural language sentences and adds the combined sentence to the existing Vector DB 45.

### Processing Flow

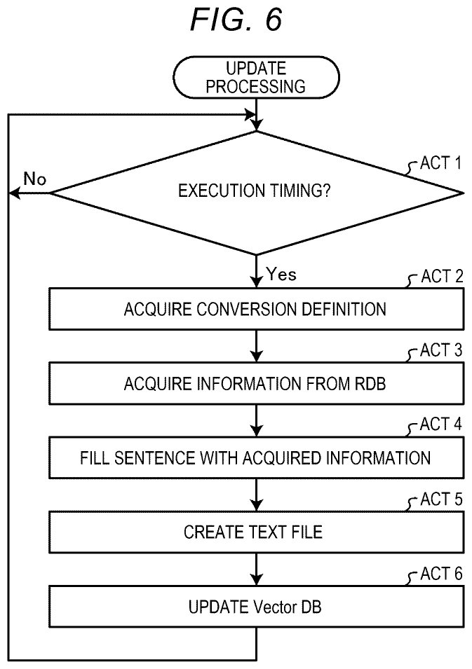

FIG. 6 is a flowchart illustrating an example of a flow of the conversion processing by the processing unit 305. First, the processing unit 305 checks whether it is time to execute processing and waits (No in ACT 1) until the time arrives. When the time to execute the processing comes (Yes in ACT 1), the processing unit 305 acquires the conversion definition file 395, that is, reads the conversion definition file 395 from the storage unit 39 (ACT 2).

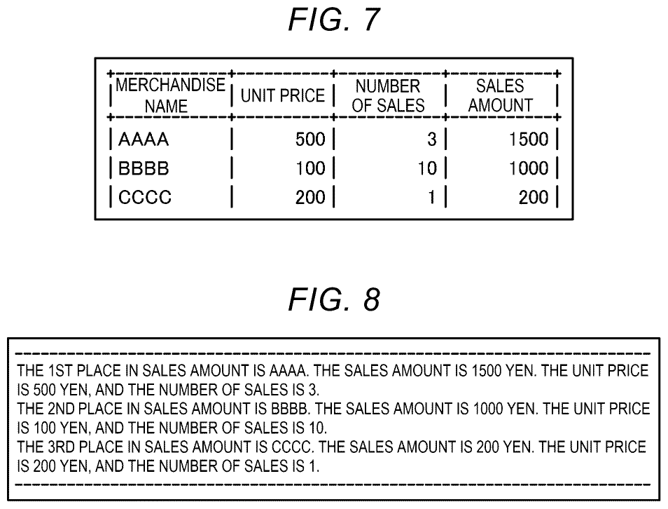

Next, the processing unit 305 executes the SQL statement defined by the conversion definition file 395 and accordingly extracts (acquires) data from the RDB 4 (ACT 3). FIG. 7 is a diagram illustrating an example of the data extracted from the RDB 40. In the example of FIG. 7, as a result of executing an SQL statement, (values) data for the items “merchandise name”, “unit price”, “number of sales”, and “sales amount” is acquired.

Next, the processing unit 305 converts the data acquired from the RDB 40 according to the conversion rule as defined by the conversion definition file 395. Specifically, the processing unit 305 fills the preset text sentence with the information acquired by executing the SQL statement (ACT 4). FIG. 8 is a diagram illustrating an example of a filled text sentence.

In the example illustrated in FIG. 8, the data illustrated in FIG. 7 has been converted into natural language according to the conversion rule defined in the conversion definition file 395. The data illustrated in FIG. 7 is assigned to blanks surrounded by brackets in the text sentence as part of the conversion rule. That is, when the text sentence associated with the SQL statement executed in ACT 3 is “The {no} place in sales amount is {merchandise name}. The sales amount is {sales amount} yen. The unit price is {unit price} yen, the number of sales is {the number of sales}”, then the {merchandise name} is replaced with “AAAA”. Similarly, {sales amount} is replaced with “1500”, {unit price} is replaced with “500”, and {sales amount} is replaced with “3”. The blank portion {No} is filled in with the ranking (rank number).

The text sentence converted by such processing thus reads, “The 1st place in sales amount is AAAA. The sales amount is 1500 yen. The unit price is 500 yen, and the number of sales is 3.” The number of text sentences generated matches the number of lines resulting from the execution of the SQL statement illustrated in FIG. 7. In the example of FIG. 7, the total number of lines is three. The text sentences illustrated in FIG. 8 are obtained by executing the processing described above for all the SQL statements and all the conversion rules included in the conversion definition file 395.

In the examples illustrated in FIGS. 3, 7, and 8, the data acquired from the RDB 40 is not divided by period (that is, each comes from the same time period for analysis), but the analysis periods can be appropriately set, for example, by designating the most recent week's worth of data as the analysis period or otherwise. In such a case, it is generally preferable that a description of the designated period is also provided in the text sentence associated with the SQL statement.

Referring back to FIG. 6, the processing unit 305 collects the filled text sentences into a document to create a text file (ACT 5). Next, the processing unit 305 adds (updates) information to the Vector DB from the created text file (ACT 6). Then, the processing unit 305 returns the processing to ACT 1.

As described above, by using a text sentence as illustrated in FIG. 8 for updating the Vector DB 45, a Vector DB 45 generally reflecting information from RDB 40 can be obtained. By periodically executing such processing, consistency between the information in the RDB 40 and the Vector DB 45 can be maintained.

### Provision of Conversion Definition

The provision (such as creation and maintenance) of the conversion definition file 395 will be described. For example, as the conversion definition file 395, a base file may be first prepared on the developer side when the system is first introduced. Alternatively, the developer prepares templates corresponding to the business category or the business type to which the system may be provided. For example, the developer provides an SQL statement and a conversion rule for use in analysis of a small retailer system and another SQL statement and conversion rule for use by a mass market retailer.

At the time of introduction, a template suitable for different business category or the business type may be selected, and customizations such as partial correction, deletion, or addition to the base template can be performed according to the end-use purpose or at the request of the end-use customer. Accordingly, a conversion definition file 395 in which the data to be acquired and the way of answering are adjusted according to the analysis desired by the end user is created.

After the introduction, it is preferable that the conversion definition file 395 is appropriately maintained according to the desire of the end user. For example, when additional information that needs to be analyzed arises while the system is in use, the existing conversion rules can be replaced or new conversion rules can be added.

In the present example, there are two SQL statements and corresponding conversion rules (FIG. 3) and one type of execution result (FIG. 7) and one type of text sentence (FIG. 8), but it is possible that a larger number of SQL statements for different analysis types can be prepared and executed.

By preparing the initial conversion definition file 395 to be used as a base file, although a large number of SQL statements and conversion rules need to be created, often the conversion definition file 395 thus generated can be reused for similar or related fields, so efficiency over the long term can be obtained by reuse or modification of a previously generated base file.

### Regarding Answer by Analysis Based on Vector DB

For example, when the RDB 40 stores transaction information and the transaction information is to be reflected in the Vector DB 45, whether to rewrite the transaction information weekly or add more information to that already stored or update the stored information can be selected according to a policy preference of the store or the like in which the system is introduced.

If the Vector DB 45 is rewritten each time a periodic update is performed, then the overall storage capacity required can be reduced, but the total amount of information incorporated is limited. When the Vector DB 45 stores more information based on past SQL execution results, then more information is available to answer the questions of the users, but this requires an increase in storage capacity.

For example, when the answer to a question of the user requires data that is not present in the Vector DB 45, the LLM 11 may not be able to return an appropriate answer. In such a case, the LLM 11 may return an answer such as “unknown”, return an estimated or approximate answer based on the closest available information, or return an answer corresponding to the nearest similar matter available.

In one embodiment, a user visiting a clothing store uses the I/O device 5 provided on the sales floor to ask a question such as, “What are the top three most popular items?” In this case, the I/O device 5 transmits the user's question to the information processing device 3. Upon receiving the question, the information processing device 3 obtains an answer via the LLM 11 and transmits the obtained answer to the I/O device 5. The I/O device 5 presents the answer to the user by, for example, a GUI displayed on the display unit 55.

Upon receiving the question, the LLM 11 acquires information from the Vector DB 45 based on the content of the question and generates a natural language response as an answer. For example, when the question of the user is, “What are the top three most popular items?”, the LLM 11 acquires merchandise information for three different merchandise items in descending order of the number of sales within the most recent preset time period from among all merchandise items available in the store. The preset time period is, for example, one week or one month. Then, the LLM 11 generates an answer by converting the acquired sales information into a natural language response.

As described above, according to the present embodiment, an answer to a question involving an analysis of information stored in the database can be obtained by interaction in natural language via the LLM. That is, according to the present embodiment, the information stored in a periodically updated database can be accessed by interaction in natural language.

When information is to be directly acquired from RDB 40 (that is, without using the Vector DB 45), the LLM has to learn the specific data structure of the RDB 40, but there is no need for such learning in the present embodiment. According to the present embodiment, an appropriate SQL statement and an appropriate conversion rule are by set up (and periodically updated), enabling usage of the information of the RDB 40 even when such is updated daily. Similarly, even when the data table configuration of a RDB 40 is changed, such a change can be handled by modifying the conversion definition e 395, which is relatively simple.

The information managed by the RDB 40 in the embodiment described above is sales data of a retail store, but implementation is not limited thereto. That is, in implementation, an embodiment may be applied to a system used in another business category or another business type. For example, an embodiment may be applied to an information processing system for logistics and delivery. In such a case, the RDB 40 manages logistics data in which various information related to the delivery of articles is collected, and a user can ask questions about receiving and shipping, arrival date and time, the size and type of packages, the delivery method, personnel, and the like and then receive answers.

### Modification

Next, a modification of an embodiment will be described. In description of the modification, aspects different from the already described embodiment will be primarily described, and description n of those aspects that are the same or substantially similar to those already described may be omitted.

The conversion definition file 395 may include designation of execution times for an SQL statement, such as “only execute from July to August” “only execute from January 1st to 3rd” or “only execute on days when the temperature is 30° C. or higher”. Accordingly, a reduction in periodic processing can be achieved.

In addition, the conversion definition file 395 may reflect information about an event near the store. For example, a designation related to the execution of an SQL statement may be included such as “execute only for data on a day coinciding with an event A”. Information about such an event (e.g., event A) can be acquired from outside the system via, for example, the network 2 (the Internet).

In some examples, the conversion definition file 395 may be divided into a plurality of separate or distinct files having different intended use times. For example, the conversion definition file 395 may be divided into a file for general year-round use and a file for a specific season. Accordingly, a processing load can be reduced by selecting and using the appropriate conversion definition file 395 rather than reading from a larger conversion definition file 395 in which a large number of SQL statements are listed d together with various execution conditions for each.

A program executed by each device in an embodiment can be incorporated in advance in an ROM or the like. The program executed by each device in an embodiment described above may be provided by being recorded in a non-transitory, computer-readable recording medium such as a CD-ROM, a flexible disk (FD), a CD-R, or a digital versatile disk (DVD) as a file in an installable or executable format.

The program executed by each device in an embodiment may be provided by being stored in a computer connected to a network, such as the Internet, and then downloaded via the network. The program executed by each device in an embodiment may be accessed or distributed via a network such as the Internet.

While certain embodiments have been described, these embodiments have been presented by way of example only, and are not intended to limit the scope of the disclosure. The novel embodiments described herein may be embodied in a variety of other forms; and various omissions, substitutions, changes, and combinations in the form of the embodiments described herein may be made without departing from the spirit of the disclosure. The embodiments and the modifications thereof are included in the scope and the gist of the disclosure, and are included in the scope of the disclosure disclosed in the claims and equivalents thereof.

What is claimed is:

1. An information processing system, comprising:
a structured database accessible by a specialized query language; and
an information processing device configured to:
receive a natural language query related to information in the structured database, and
provide a natural language response to the natural language query by supplying the natural language query to a large language model (LLM) accessing a retrieval-augmented generation (RAG) database incorporating information from the structured database, wherein
the information processing device is further configured to:
automatically update information in the RAG database by retrieving information from the structured database by:
executing a predefined query in the specialized query language to access the structured database,
converting results from the predefined query into natural language text according to a predefined conversion rule associated with the predefined query, and
storing the natural language text in the RAG database.

2. The information processing system according to claim 1, wherein the information in the RAG database is unstructured.

3. The information processing system according to claim 1, wherein the structured data base is a relational database.

4. The information processing system according to claim 1, wherein the specialized query language is a structured query language (SQL).

5. The information processing system according to claim 1, wherein the information processing device stores a plurality of predefined queries in the specialized query language.

6. The information processing system according to claim 5, wherein the information processing device stores each of the plurality of predefined queries in association with a corresponding predefined conversion rule for the predefined query.

7. The information processing system according to claim 1, wherein the information in the structured database includes merchandise sales data for a retail store.

8. The information processing system according to claim 1, wherein the information processing device is configured to receive the natural language query from a user terminal across a network.

9. The information processing system according to claim 1, wherein the LLM is provided as a cloud-based service to the information processing device.

10. The information processing system according to claim 9, wherein the RAG DB is stored on a storage unit in the information processing device.

11. The information processing system according to claim 10, wherein the structured database is stored on the storage unit in the information processing device.

12. The information processing system according to claim 1, wherein the information processing device is configured to automatically update information in the RAG database at a fixed interval.

13. The information processing system according to claim 12, wherein the fixed interval is daily.

14. The information processing system according to claim 1, wherein the information in the RAG database is stored in a vectorized format.

15. An information processing device, comprising:
a storage unit; and
a processing unit configured to:
receive a natural language query related to information in a structured database accessible by a specialized query language, and
provide a natural language response to the natural language query by supplying the natural language query to a large language model (LLM) accessing a retrieval-augmented generation (RAG) database incorporating information from the structured database, wherein
the processing unit is further configured to:
automatically update information in the RAG database by retrieving information from the structured database by:
executing a predefined query in the specialized query language to access the structured database,
converting results from the predefined query into natural language text according to a predefined conversion rule associated with the predefined query, and
storing the natural language text in the RAG database.

16. The information processing device according to claim 15, wherein
the storage unit stores a plurality of predefined queries in the specialized query language, and
each of the plurality of predefined queries is stored in association with a corresponding predefined conversion rule for the predefined query.

17. The information processing device according to claim 15, wherein the structured database and the RAG database are stored in the storage unit.

18. The information processing device according to claim 17, wherein the LLM is provided as a cloud-based service.

19. An information processing method for accessing a structured database via a natural language query, the method comprising:
receiving, at an information processing device, a natural language query related to information in a structured database stored on the information processing device and accessible by a specialized query language;
providing a natural language response to the natural language query by supplying the natural language query to a cloud-based large language model (LLM) accessing a retrieval-augmented generation (RAG) database incorporating information from the structured database, the RAG database being stored on the information processing device; and
automatically updating information in the RAG database by retrieving information from the structured database at a fixed interval by:
executing a predefined query in the specialized query language to access the structured database,
converting results from the predefined query into natural language text according to a predefined conversion rule associated with the predefined query, and
storing the natural language text in the RAG database.

20. The information processing method according to claim 19, wherein the information in the structured database includes merchandise sales data for a retail store.
